(19) United States
(12) Patent Application Publication
(10) Pub. No.: US 2008/0111700 A1
(43) Pub. Date: May 15, 2008

(54) RECORDABLE SMOKE DETECTOR WITH RECORDED MESSAGE PLAYBACK VERIFICATION SYSTEM

(76) Inventor: Bart Smudde, Cumming, GA (US)

Correspondence Address: AKERMAN SENTERFITT, P.O. BOX 3188, WEST PALM BEACH, FL, 33402-3188, US

(21) Appl. No.: 11/558,242

(22) Filed: Nov. 9, 2006

(51) Int. Cl. G08B 17/10

(52) U.S. Cl. 340/628

(57) ABSTRACT

A recordable smoke detector configured to record a message to be played in an alarm condition. The recordable smoke detector includes a testing system configured to play the recorded message to determine whether one or more quantifiable characteristics of the recorded message meets a predetermined threshold, thereby signifying that the recorded message is operable at a safe sound intensity capable of waking a sleeping person.

### FIELD OF THE INVENTION

The invention is directed generally to smoke detectors, and more particularly, to recordable smoke detectors capable of playing recorded messages upon detecting an alarm condition, such as smoke.

### BACKGROUND

There exist numerous types of smoke detectors. Some smoke detectors produce an audible alarm, such as an alarm generated from a buzzer or a speaker, while other smoke detectors produce a visual alarm. The success of smoke detectors with audible alarms in awakening sleeping people correlates directly with the quality of the sound generated by the smoke detector and the type of audible alarm produced. For instance, tests have shown that children experience deeper stages of non-rapid eye movement (NREM) sleep, particularly at stages three and four, than adults and have higher arousal thresholds. As a result, more often than not, children sleep through the alarms, such as buzzers and sirens, found in conventional smoke detectors. These tests have also shown that children are very likely to wake up from a deep sleep when they hear a recognizable voice, such as the voice of one of their parents.

As a result of these tests, smoke detectors capable of replaying voice recordings have been developed that enable parents to record their voice on a smoke detector so that when the smoke detector detects the presence of smoke, the smoke detector plays the recorded, familiar voice of a parent instructing the child to wake up and leave the room as previously taught. Smoke detectors such as these have proven to be more successful in awakening sleeping children than conventional smoke alarms.

The recorded messages are received by a sound recording device, such as, but not limited to, a microphone, and stored on the smoke detectors. The volume and clarity of the recorded messages may vary based upon the voice of the person creating the recorded message, the distance of the person's mouth from the sound recording device, and other factors. Nonetheless, it is important that the message be recorded at a sufficient volume to enable the message to be replayed clearly and with sufficient volume to wake a sleeping person. Thus, a need exists for a way of determining whether a message has been recorded properly such that when replayed, the message is played with sufficient volume to wake a sleeping person.

### SUMMARY OF THE INVENTION

The invention is directed to a recordable smoke detector for detecting smoke and creating at least an audible alarm for informing occupants of a home of the existence of a fire. The recordable smoke detector includes a detection device for identifying the presence of smoke and a voice recording and playback module for recording a message to be played upon an alarm condition being sensed. The recordable smoke detector may also include a sound recording device in communication with the voice record module and configured to receive an alarm message and a sound producing device for playing the voice recording. The recordable smoke detector may also include voltage level comparator, such as an analog to digital converter, in communication with the sound producing device and a control module for controlling the sound producing device. The control module may include a testing system configured to cause the voice recording and playback module to play the recorded message during which the control module analyzes at least one quantifiable characteristic of the recorded message to determine whether a predetermined threshold is met signifying that the recorded message is operable at a level, such as sound intensity, capable of waking a sleeping person.

The quantifiable characteristic that may be analyzed may be the root mean square (RMS) voltage applied to the sound producing device, the average peak voltage applied to the sound producing device, the peak-to-peak voltage applied to the sound producing device, or other appropriate characteristics. In one embodiment, the peak-to-peak voltage may be between about five volts and about ten volts, the average peak voltage may be between about three volts and about five volts, and the RMS voltage may be about 2.8 volts. In one embodiment, the sound producing device may be rated at one watt and have an impedance of eight ohms. In such an embodiment, the corresponding voltage level into the sound producing device that may replay a message at a volume of about 87 decibels at 0.25 meters with 2.88 volts root mean square (RMS), 4.07 average peak volts, and 8.15 volts peak-to-peak.

During use, the control module 18 may prompt a person to record a message and control the message recording process. The person may talk into the sound recording device to record the message. The sound recording device may transmit the message to the voice recording and playback module. After the person has finished recording the message, the control module stops the voice recording and playback module and may control the playback of the message. During message playback, the control module may monitor the playback message to determine whether the message is being played with sufficient sound intensity, such as power per unit area, to awaken a sleeping person In at least one embodiment, the control module may monitor the voltage level comparator to determine the voltage of the electrical signal sent from the voice recording and playback module to the sound producing device. The control module may store the maximum and minimum peak voltage values of the electrical signal while the message is played.

Once the voice recording and playback module completes playing the message, the control module analyzes the maximum and minimum voltages of the electrical signal to determine whether the peak-to-peak amplitude, such as the average peak-to-peak amplitude of the electrical signal is greater than a predetermined minimum threshold. The control module may include software configured to analyze the peak-to-peak voltage, the average peak voltage, the RMS voltage, and other appropriate quantifiable characteristics of the recorded message. If the peak-to-peak amplitude is less than the predetermined minimum level, the user may be prompted to re-record the message. Otherwise, the recordable smoke detector indicates to the user that the recording is sufficient, such as through an LED, display screen or other appropriate manner. Such a system ensures that the message is properly recorded so that when the message is played, it is played at a sound intensity sufficient to wake a sleeping person.

An advantage of this invention is that the recordable smoke detector is able to determine whether the recorded message has been recorded such that the message may be replayed with sufficient sound intensity to wake a sleeping person, and if the message has not been recorded correctly, the system may prompt the user to re-record the message.

These and other advantages and embodiments of the invention are described below.

### BRIEF DESCRIPTION OF THE DRAWING

The accompanying drawing, which is incorporated in and forms part of the specification, is a schematic diagram of the invention and illustrates a preferred embodiment of the presently disclosed invention(s).

### DETAILED DESCRIPTION OF THE INVENTION

This invention is directed to a recordable smoke detector 10, as shown in the figure, that is capable of recording a message to be played during an alarm condition rather than a conventional fire alarm siren. The recordable smoke detector 10 may have a testing system 12 configured to determine whether the voice recording play back has sufficient sounds intensity to wake a sleeping person, in particular, a child. In at least one embodiment, the testing system 12 may be configured to cause a voice recording and playback module 14 to play the recorded message through a sound producing device 16 during which a control module 18 may analyze at least one quantifiable characteristic of the recorded message to determine whether a predetermined threshold is met signifying that the recorded message is operable at a safe level of sufficient sound intensity capable of waking a sleeping person.

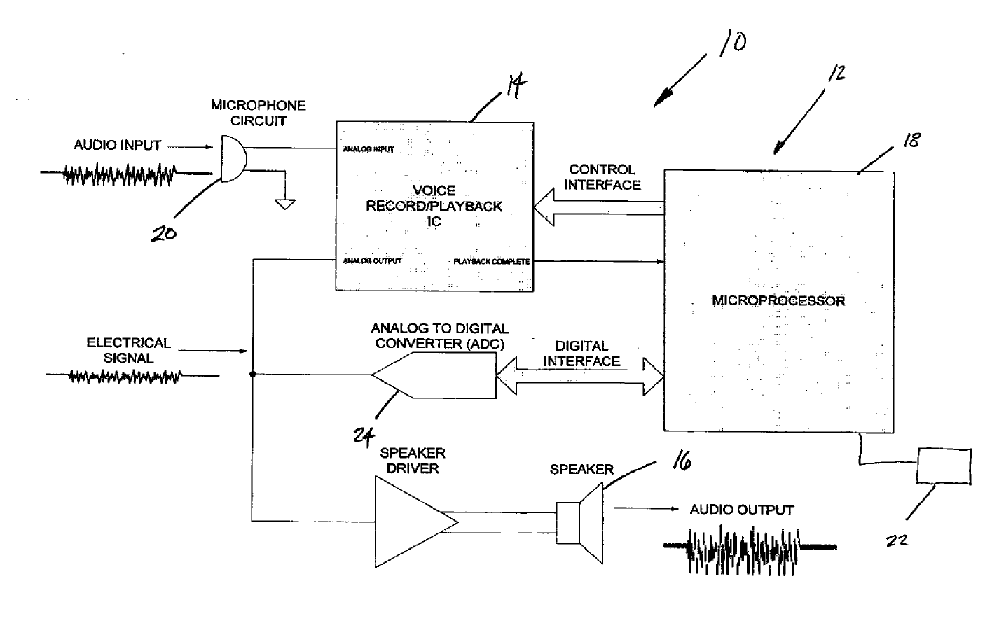

As shown in FIG. 1, the recordable smoke detector 10 may be configured to sense a fire condition through a detection device 22. The recordable smoke detector 10 may be configured to detect a fire condition with one or more types of detection devices 22, such as, but not limited to, a carbon dioxide sensor and other appropriate devices. The recordable smoke detector 10 may also include the voice recording and playback module 14 for receiving a recorded message. The voice recording and playback module 14 may store the message in the module 14 or in another appropriate location, such as, but not limited to, a control module 18. The voice recording and playback module 14 may be in communication with a sound recording device 20, such as, but not limited to, a microphone, silicon chip or other appropriate device, that enables messages to be recorded. The sound recording device 20 may be any appropriate sound recording device that is compatible with the detector 10 and is sized appropriately for the system.

The recordable smoke detector 10 may also include a sound producing device 16 for playing the voice recording. In at least one embodiment, the sound producing device 16 may be a speaker or other appropriate device. The recordable smoke detector 10 may also include the control module 18 for controlling the sound producing device 16. The control module 18 may include the testing system 12 configured to cause the voice recording and playback module 14 to play the recorded message during which the control module 18 analyzes at least one quantifiable characteristic of the recorded message to determine whether a predetermined threshold is met signifying that the recorded message is operable at a safe level of sufficient sound intensity capable of waking a sleeping person. The quantifiable characteristic that may be analyzed may be the root mean square (RMS) voltage applied to the sound producing device 16, the average peak voltage applied to the sound producing device 16, the peak-to-peak voltage applied to the sound producing device 16, such as average peak-to-peak voltage, or other appropriate characteristic. In one embodiment, the peak-to-peak voltage thresholds may be between about five volts and about ten volts, the average peak voltage threshold may be between about three volts and about five volts, and the RMS voltage threshold may be about 2.8 volts. In one embodiment, the sound producing device 16 may be rated at one watt and have an impedance of eight ohms. In such an embodiment, the corresponding voltage threshold into the sound producing device 16 may be 2.88 volts root mean square (RMS), 4.07 average peak volts, and 8.15 volts peak-to-peak.

During use, the control module 18 may prompt a person to record a message and may control the message recording process. The person may talk into the sound recording device 20 to record the message. For instance, the person may say “Wake up Johnny, Wake up. There is a fire in the house. Please get out of the house and meet us on the front street as we have practiced.” The sound recording device 20 may transmit the message to the voice recording and playback module 14. After the person has finished recording the message, the control module 18 may stop the voice recording and playback module 14.

The control module 18 may control the playback of the message from the voice recording and playback module 14. During message playback, the control module 18 may monitor the playback message to determine whether the message is being played with sufficient sound intensity to awaken a sleeping person. In at least one embodiment, the control module 18 may monitor a voltage level comparator 24, which may be an analog to digital converter, to determine the voltage of the electrical signal sent from the voice recording and playback module 14 to the sound producing device 16. The control module 18 may store the maximum and minimum peak voltage values of the electrical signal while the message is played.

Once the voice recording and playback module 14 completes playing the message, the control module 18 analyzes the maximum and minimum voltages of the electrical signal to determine whether the peak-to-peak amplitude of the electrical signal is greater than a predetermined minimum threshold such as previously described. The control module 18 may include software configured to analyze the peak-to-peak voltage, the average peak voltage, the RMS voltage, and other appropriate quantifiable characteristics of the recorded message. If the peak-to-peak voltage amplitude is less than the predetermined minimum level, the user may be prompted to re-record the message. Otherwise, the recordable smoke detector 10 indicates to the user that the recording is sufficient, such as through an LED, display screen or other appropriate manner.

The foregoing is provided for purposes of illustrating, explaining, and describing embodiments of this invention. Modifications and adaptations to these embodiments will be apparent to those skilled in the art and may be made without departing from the scope or spirit of this invention.

We claim:

1. A recordable smoke detector, comprising:
a detection device for identifying the presence of smoke;
a voice recording and playback module for recording a message to be played upon an alarm condition being sensed;
a sound recording device in communication with the voice record module and configured to receive an alarm message;
a sound producing device for playing the voice recording;
a voltage level comparator in communication with the sound producing device; and
a control module for controlling the sound producing device, wherein the control module includes a testing system configured to cause the voice recording and playback module to play the recorded message during which the control module analyzes at least one quantifiable characteristic of the recorded message to determine whether a predetermined threshold is met signifying that the recorded message is operable at a level capable of waking a sleeping person.

2. The recordable smoke detector of claim 1, wherein the quantifiable characteristic is peak-to-peak voltage amplitude of the recorded message.

3. The recordable smoke detector of claim 2, wherein the quantifiable characteristic is an average peak-to-peak voltage amplitude of the recorded message.

4. The recordable smoke detector of claim 2, wherein the sound producing device is rated at one watt and eight ohms of impedance, and the peak-to-peak voltage amplitude is between about five volts and about ten volts.

5. The recordable smoke detector of claim 4, wherein the peak-to-peak voltage amplitude is about eight volts.

6. The recordable smoke detector of claim 1, wherein the quantifiable characteristic is an average peak value of voltage amplitude of the recorded message.

7. The recordable smoke detector of claim 6, wherein the sound producing device is rated at one watt and eight ohms of impedance, and the average peak value of voltage amplitude of the recorded message is between about three volts and about five volts.

8. The recordable smoke detector of claim 7, wherein the average peak value of voltage amplitude of the recorded message is about four volts.

9. The recordable smoke detector of claim 1, wherein the quantifiable characteristic is root mean square voltage.

10. The recordable smoke detector of claim 9, wherein the sound producing device is rated at one watt and eight ohms of impedance, and the root mean square voltage amplitude is about 2.8 volts.

11. A method of testing a recordable smoke detector, comprising:
playing a recorded message from a recordable smoke detector, the smoke detector comprising:
a detection device for identifying the presence of smoke;
a voice recording and playback module for recording a message to be played upon an alarm condition being sensed;
a sound recording device in communication with the voice record module and configured to receive an alarm message;
a sound producing device for playing the voice recording;
a voltage level comparator in communication with the sound producing device; and
a control module for controlling the sound producing device, wherein the control module includes a testing system configured to cause the voice recording and playback module to play the recorded message during which the control module analyzes at least one quantifiable characteristic of the recorded message to determine whether a predetermined threshold is met signifying that the recorded message is operable at a level capable of waking a sleeping person; and
determining whether the message produced by the sound producing device of the recordable smoke detector exceeds a predetermined threshold.

12. The method of claim 11, wherein the sound producing device is rated at one watt and eight ohms of impedance, and determining whether the message produced by the sound producing device exceeds a predetermined threshold comprises determining whether a signal sent from the voltage level comparator to the sound producing device has minimum peak-to-peak voltage between about five volts and about ten volts.

13. The method of claim 12, wherein determining whether the message produced by the sound producing device exceeds a predetermined threshold comprises determining whether the sound producing device has a minimum peak-to-peak voltage greater than about eight volts.

14. The method of claim 11, wherein the sound producing device is rated at one watt and eight ohms of impedance, and determining whether the message produced by the sound producing device exceeds a predetermined threshold comprises determining whether a signal sent from the voltage level comparator to the sound producing device has an average peak voltage of between about three volts and about five volts.

15. The method of claim 14, wherein determining whether the message produced by the sound producing device exceeds a predetermined threshold comprises determining whether the sound producing device has an average peak voltage greater than about four volts.

16. The method of claim 11, wherein the sound producing device is rated at one watt and eight ohms of impedance, and determining whether the message produced by the sound producing device exceeds a predetermined threshold comprises determining whether a signal sent from the voltage level comparator to the sound producing device has a root mean square voltage of greater than about 2.8 volts.
